(19) United States
(12) Patent Application Publication
(10) Pub. No.: US 2006/0262518 A1
(43) Pub. Date: Nov. 23, 2006

(54) Flashlight tool

(75) Inventors: Michael Thuma, LaGrange, IL (US); Paul Mann, Oak Park, IL (US)

Correspondence Address: Vasilios D. Dossas;Niro, Scavone, Haller & Niro, Suite 4600, 181 W. Madison, Chicago, IL, 60602, US

(73) Assignee: NTM INDUSTRIES, LLC

(21) Appl. No.: 11/130,933

(22) Filed: May 17, 2005

(51) Int. Cl. B25B 23/18

(52) U.S. Cl. 362/119; 362/120; 362/199

(57) ABSTRACT

A flashlight tool that includes a base member and a light emitting member. These members lie pivotably connected to one another. The base member can be two-part and have an upper part and a lower part also pivotably connected to each other. The upper part of the base member can contain a set of fold out tools to form a versatile tool kit that can include a knife blade, scissors, saw, can opener, and insert socket. In addition, the base member can contain a clipped cigarette lighter or match box for lighting a fire. The base member can be optionally used as a digging tool. The light emitting member can be separate from the base member.

### BACKGROUND OF THE INVENTION

1. Field of the Invention

The present invention relates to a flashlight tool apparatus, and more particularly to an articulated flashlight apparatus including a light emitting member and a base member that can contain a multi-function tool which provides a stable base and allows the light emitting member to assume multiple positions.

2. Description of the Prior Art

The prior art includes a wide variety of utility flashlights, including light weight, pocket size devices found in the commercial and camping markets. The most notable of the pocket size devices is the MAGLITE (™) line of flashlights. These devices typically include a light bulb, batteries and a housing to contain them, as do most conventional flashlights.

The prior art also includes a number of multi-functional tools that combine different tool heads into a common handle. The tool heads fold or pivot into the handle, and they can unfold or pivot out of the handle (either separately or collectively). The most notable of these devices is the SWISS ARMY (™) line of products.

It is desirable for a pocket size flashlight to include support structure for placing the flashlight in different positions and allowing hands-free operation of the flashlight. It is also desirable for a pocket size multifunction tool to include a flashlight as one of its components. Finally, it is desirable that these tools and flashlights have a compact and a light weight construction.

The flashlight tool apparatus of the present invention provides a pocket size, multi-function tool with a flashlight component that can be separated into a light emitting part and a two-part base. The stable, two-part base allows an operator to place the flashlight component in a number of positions without holding it there with his or her hands. The construction is simple and compact; it is light weight and easy to manufacture and operate.

### SUMMARY OF THE INVENTION

In accordance with this invention, a flashlight apparatus includes a two-part base member with an upper part and a lower part pivotably connected at one end, and a light emitting member that is itself pivotably connected to the upper part of the base member or to a slide that mates into a channel in the upper part of the base member. The light emitting member can be separable from the base member by sliding the slide out of the channel. In one embodiment, the upper part of the base member includes a pocket size multi-function tool disposed in end-to-end relation with the light emitting member. The base member allows the flashlight to sit upright and assume different angles toward which the light beam can be pointed. The lower part of the base member itself can be independently used as a digging tool with the upper part acting as a handle.

### BRIEF DESCRIPTION OF THE DRAWINGS

For a more complete understanding of this invention, one should now refer to the embodiments illustrated in greater detail in the accompanying drawings and described below as examples of the invention. In the drawings:

FIG. 1 is a perspective view of an embodiment of the flashlight tool apparatus of the present invention with the tools folded.

FIG. 2 is a side view of the embodiment of FIG. 1.

FIG. 3 is an end view of the support unit.

FIG. 4 is a perspective view of an embodiment of the flashlight tool with the tools unfolded and the light emitting element separated.

FIGS. 5A and 5B are detail views of the hinging mechanism between the upper and lower parts of the base member.

FIG. 6 is a perspective view of an embodiment of the flashlight tool in a totally folded configuration.

FIG. 7 shows the independent use of the base member as a digging tool.

FIG. 8 shows the use of a removable head socket tool attached to the base member.

While the following disclosure describes the invention in connection with one embodiment and a number of modifications, one should understand that the invention is not limited to this embodiment. Furthermore, one should understand that the drawings are not to scale and that graphic symbols, diagrammatic representations and fragmentary views, in part, may illustrate the embodiment. In certain instances, the disclosure may not include details which are not necessary for an understanding of the present invention.

### DETAILED DESCRIPTION OF THE INVENTION

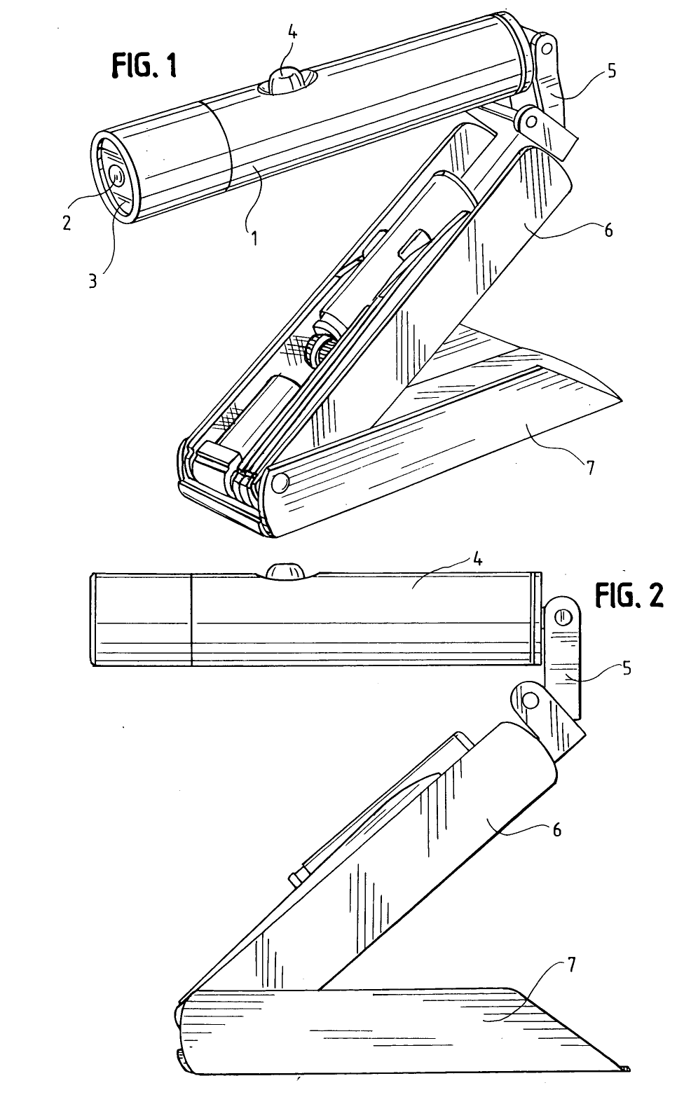

Turning now to the drawings and referring specifically to FIGS. 1 and 2, the flashlight tool of the present invention can be seen. A light emitting member 1 is pivotably connected to a base member 6, 7 through a pivot assembly 5. The base member has an upper part 6 and a lower part 7 pivotably connected to each other. The light emitting member 1 can have an optional switch or button 4 associated with it to turn the light off and on. A light source 2 can be mounted in the front of the light emitting element 1 with an optional lens 3 and can be either an LED or a conventional bulb. It is preferred to use an LED because LEDs are brighter, can optionally be chosen in different colors and last longer. The light emitting member 1 includes a housing that can hold the light emitting element, batteries and the switch. The housing can be made from aluminum or any other material of high strength and rigidity.

The base member with a upper part 6 and a lower part 7 can pivot to different angles from completely folded to almost straight and can thus be used to point the light beam from the light emitting member 1 into almost any angle. The lower part of the base member 7 has a flat bottom and provides a very stable base upon which to place the flashlight tool on any reasonably flat surface. Because the flashlight tool of the present invention is made for pocket use, especially outdoors, the base can be placed on the ground, on a table, on a car fender or almost anywhere to hold the light.

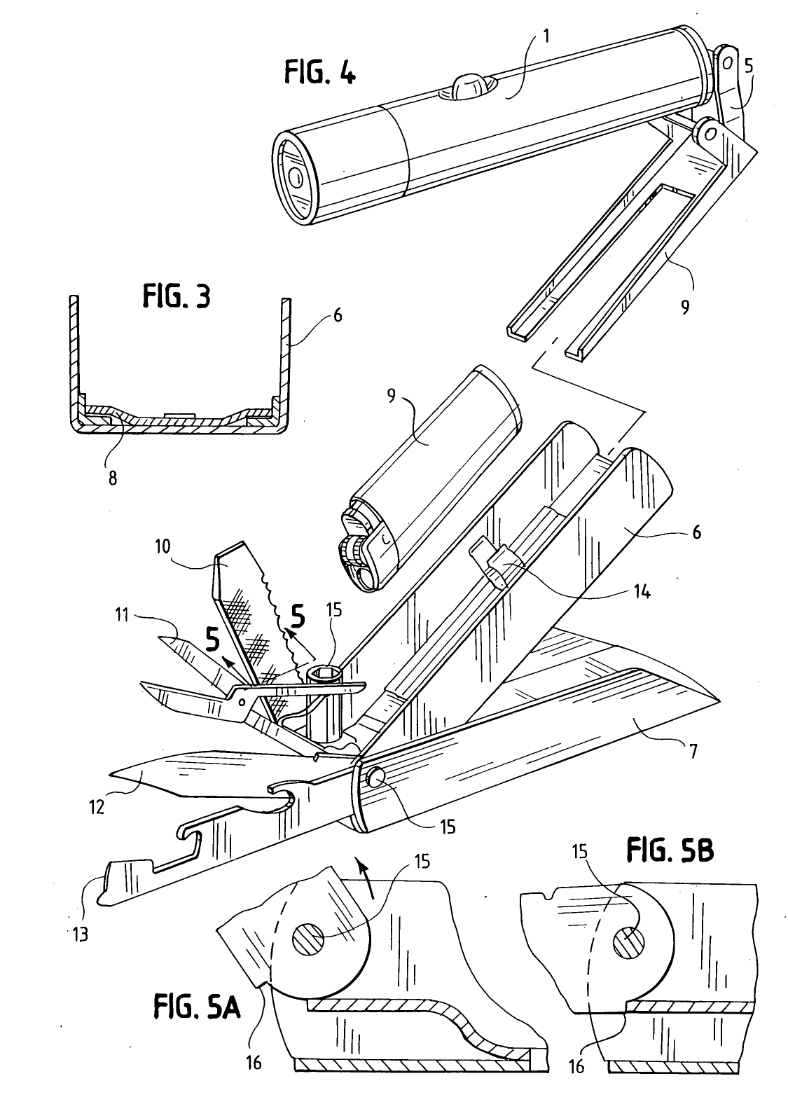

FIGS. 3-4 show how the light emitting member 1 can separate from the base member 6, 7. The pivot 5 is attached at one point to the light emitting member 1 and at another point to a slide member 9. The slide member can be as shown in FIG. 4 with two separate forks, or it can be a single continuous piece. The slide member 9 slides into a channel 8 or spring clip that is attached to the upper part 6 of the base member. This feature allows the flashlight tool of the present invention to be separated into two parts, a lower part containing tools, and an upper part containing the light emitting element.

The upper part 6 of the base member can be shaped like a channel and can optionally contain a set of folding tools where each tool is connected on a pin 15 or other pivot means that runs across one end of the channel. Several different tools can be stacked side-by-side in parallel fashion to provide a versatile tool kit. For example, FIG. 4 shows a saw 10, a pair of scissors 11, a knife blade 12, an insert socket 15 and a multi-purpose can/bottle opener 13. The flashlight tool of the present invention can contain any possible tools or combination of tools and is not limited to the tools shown in FIG. 4.

The side-by-side tools generally ride on the pin 15 which traverses the channel making up the upper part 6 of the base unit. It is advantageous to optionally provide a stop so that the tools cannot pivot past a 180 degree angle with the base. Details of a possible stop are shown in FIGS. 5A and 5B. FIG. 5A shows the outer tool rotated to about a 110 degree angle with respect to the base; the stop 16 is not engaged. FIG. 5B shows the tool rotated to a 180 degree angle with respect to the base and the stop 16 engaged.

The upper part 6 of the base member can optionally contain a clip 14 which can releasably hold a cigarette lighter 9 or any other type of flame source such as a box of matches or waterproof matches. This feature can be particularly useful for camping.

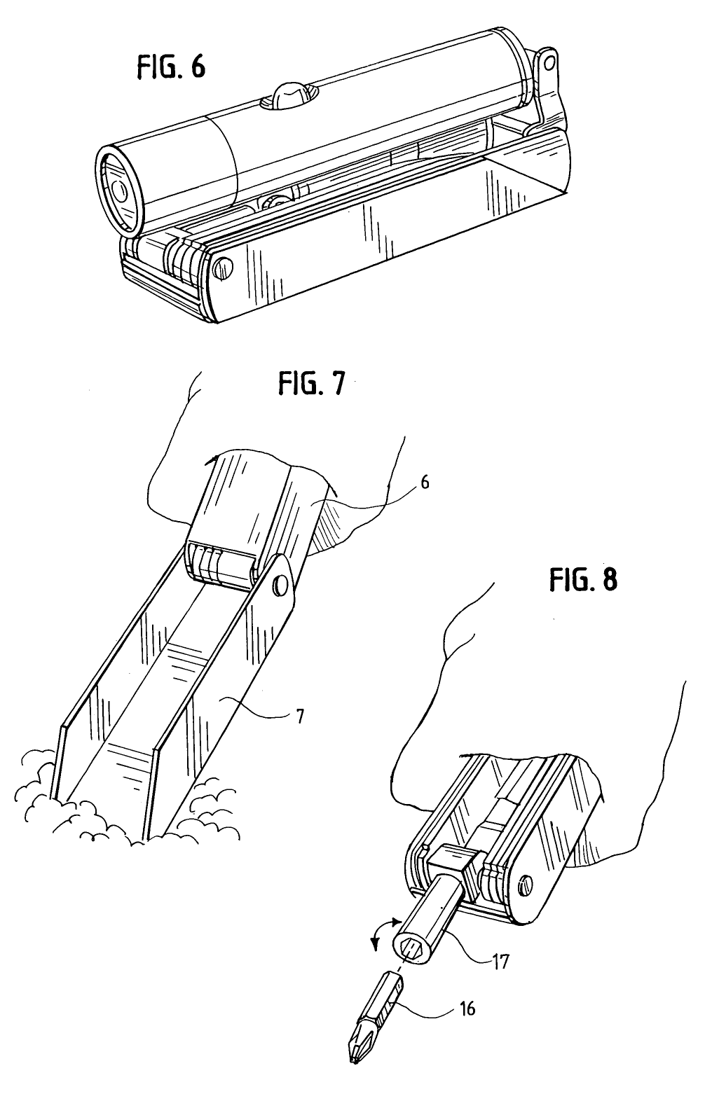

The flashlight tool of the present invention can be totally folded for pocket carrying (or inserted in an optional carrying case). FIG. 6 shows the flashlight tool in a totally folded configuration.

An optional use of the base member 6, 7 is as a digging tool. In this case, the end of the lower part 7 of the base member can be shaped with the edges of the channel slightly tapered to allow digging. FIG. 7 shows the use of the flashlight tool as a digger.

One of the possible tools that can be supplied is an insert socket 17. FIG. 8 shows the use of such an insert socket where a removable head 16 is inserted into the socket 17. The removable head can be a Philips or standard screwdriver, special screwdriver or any other insertable tool. A set of several insertable heads can be optionally carried in a carrying case adapted to hold the flashlight tool and the insertable heads.

While the above description and the drawings disclose and illustrate one embodiment and a number of modifications of that embodiment, one should understand, of course, that the invention is not limited to this embodiment. those skilled in the art to which the invention pertains may make other modifications and other embodiments employing the principles of the invention, particularly upon considering the foregoing teachings. Therefore, by the appended claims, the applicant intends to cover any modifications and other embodiments that incorporate those features which constitute the essential features of this invention.

We claim:

1. A flashlight tool comprising: a base member with upper and lower parts pivotably connected, and a light emitting member; the light emitting member pivotably connected to a slide member, said slide member sliding into a channel in the upper part of said base member.

2. The flashlight tool of claim 1 wherein said light emitting member includes and off-on switch.

3. The flashlight tool of claim 1 wherein the upper part of said base member includes a multi-function tool.

4. The flashlight tool of claim 3 wherein the multifunction tool includes a plurality of individual tools situated parallel to each other, each of said tools being pivotable connected at one end to the upper part of said base member.

5. The flashlight tool of claim 4 wherein said tools are chosen from the group consisting of a knife blade, scissors, can opener, saw, socket, and combinations thereof.

6. The flashlight tool of claim 1 further comprising a flame source snapped onto the upper part of said base member.

7. The flashlight tool of claim 6 wherein said flame source is a cigarette lighter.

8. The flashlight tool of claim 6 wherein said flame source is a box of matches.

9. The flashlight tool of claim 1 wherein said light emitting member includes a light source, a power source connected to said light source, and a housing for containing the light source and power source.

10. The flashlight tool of claim 9 wherein the housing of said light source includes a space for an auxiliary power source.

11. A flashlight apparatus comprising:
a two-part base member with an upper and lower part, said upper and lower parts pivotably connected at one end;
a light emitting member pivotably connected to a slide, said slide engaging a channel in the upper part of said base member, said light emitting member and said slide separable from said base member.

12. The flashlight tool of claim 11, wherein the upper part of said base member includes a multi-function tool.

13. The flashlight tool of claim 12 wherein the multifunction tool includes a plurality of individual tools situated parallel to each other, each of said tools being pivotable connected at one end to the upper part of said base member.

14. The flashlight tool of claim 13 wherein said tools are chosen from the group consisting of a knife blade, scissors, can opener, saw, socket, and combinations thereof.

15. The flashlight tool of claim 11 further comprising a flame source snapped onto the upper part of said base member.

16. The flashlight tool of claim 15 wherein said flame source is a cigarette lighter.

17. The flashlight tool of claim 15 wherein said flame source is a box of matches.

18. The flashlight tool of claim 11 wherein said light emitting member includes a light source, a power source connected to said light source, and a housing for containing the light source and power source.

19. The flashlight tool of claim 18 wherein the housing of said light source includes a space for an auxiliary power source.

20. The flashlight tool of claim 15 wherein said lower part of said base member includes a digging tool.
